(19) United States
(12) Patent Application Publication
(10) Pub. No.: US 2025/0379274 A1
(43) Pub. Date: Dec. 11, 2025

(54) THERMAL RUNAWAY EVENT DETECTION

(71) Applicant: INTERNATIONAL BUSINESS MACHINES CORPORATION, ARMONK, NY (US)

(72) Inventors: LAYNE A. BERGE, ROCHESTER, MN (US); DYLAN GRACE, TUCSON, AZ (US); MATTHEW A. WALTHER, BYRON, MN (US); KYLE SCHONECK, ROCHESTER, MN (US); JOHN R. DANGLER, ROCHESTER, MN (US); KEVIN DANIEL ESCOBAR, ROCHESTER, MN (US); MATTHEW DOYLE, CHATFIELD, MN (US); ALEXANDER JAY WOLSETH, ROCHESTER, MN (US); THOMAS W. LIANG, ROCHESTER, MN (US)

(21) Appl. No.: 18/735,939

(22) Filed: Jun. 6, 2024

(51) Int. Cl. H01M 10/48; G01B 7/16; H01M 10/613; H01M 10/633; H01M 10/6572

(52) U.S. Cl. CPC H01M 10/482; G01B 7/18; H01M 10/613; H01M 10/633; H01M 10/6572

(57) ABSTRACT

Thermal runaway event detection includes measuring, using an expansion sensor layered over a battery device, a rate of expansion of the battery device based on time series detections of volumetric expansion by the expansion sensor; detecting, based on the rate of expansion, conditions for a thermal runaway event; and performing a thermal runaway remediation action in response to detecting the conditions for the thermal runaway event.

### BACKGROUND

The present disclosure relates to methods, apparatus, and products for thermal runaway event detection. Lithium-ion batteries are ubiquitous in modern electronics applications, including mobile phones, tablets, laptops, electric vehicles, and so on. Unfortunately, lithium-ion batteries are susceptible to thermal runaway. Thermal runaway in a lithium-ion battery refers to a chain reaction of events that lead to an uncontrollable increase in temperature within the battery cell. Once thermal runaway begins it releases heat, causing a rise in temperature. The elevated temperature accelerates the chemical reactions within the battery, leading to further heat generation. This creates a feedback loop in which the temperature can escalate rapidly, causing damage to the electronic device, fire, or injury to users.

### SUMMARY

According to embodiments of the present disclosure, various methods, apparatus and products for thermal runaway event detection are described herein. In some aspects, thermal runaway event detection includes measuring, using an expansion sensor layered over a battery device, a rate of expansion of the battery device based on time series detections of volumetric expansion by the expansion sensor. Conditions for a thermal runaway event are detected based on the rate of expansion. A thermal runaway remediation action is performed in response to detecting the conditions for the thermal runaway event.

### BRIEF DESCRIPTION OF THE DRAWINGS

FIG. 1A sets forth a diagram of an example system for thermal runaway event detection in accordance with at least one embodiment of the present disclosure.

FIG. 1B sets forth an example of battery expansion in the example of FIG. 1A.

FIG. 2 sets forth a diagram of another example system for thermal runaway event detection in accordance with at least one embodiment of the present disclosure.

FIG. 3 sets forth a block diagram of another example system for thermal runaway event detection in accordance with at least one embodiment of the present disclosure.

FIG. 4 sets forth a block diagram of another example system for thermal runaway event detection in accordance with at least one embodiment of the present disclosure.

FIG. 5 sets forth a flow chart of an example method for thermal runaway event detection in accordance with at least one embodiment of the present disclosure.

FIG. 6 sets forth a flow chart of another example method for thermal runaway event detection in accordance with at least one embodiment of the present disclosure.

FIG. 7 sets forth an example computing environment in accordance with aspects of the present disclosure.

### DETAILED DESCRIPTION

In lithium-ion cells, the movement of electrons and lithium ions produces electricity. The process of charge and discharge is normally accompanied by a small amount of heat. In ideal conditions, the heat is able to dissipate from the cell. However, in thermal runaway, the lithium-ion cell generates heat at a rate several times higher than the rate at which heat dissipates from the cell. The cell reaches thermal runaway when its temperature rises uncontrollably (e.g., at a rate greater than 20° C. per minute) with maximum temperatures reaching greater than 300° C. accompanied by gas or electrolyte venting, smoke, fire or a combination thereof.

Battery expansion, also referred to as swelling, is typically the result of the accumulation of gases inside the battery. The heat generated by exothermic reactions leading up to thermal runaway can lead to a breakdown of the electrolyte and other materials in the battery and the production of gases as a result. The buildup of these gases alters the shape and overall volume of the battery, which may appear as bulging or swelling of the battery. However, battery expansion does not necessarily mean that the battery is experiencing a thermal runaway event. For example, gases can build up in the battery due to aging of the battery, extended use or high temperature environments, overcharging or over discharging, and so on. Thus, while in some instances a bulging battery may be a sign of an imminent thermal runaway event, in other instances a bulging battery may simply indicate that the battery should be replaced. In the case of the latter, disrupting a mission critical task may be an unnecessary or even drastic response to detecting battery expansion. Further, the degree of expansion by itself may be insufficient to detect a thermal runaway event. It is thus advantageous to differentiate between battery expansion caused by imminent thermal runaway conditions that require immediate attention and battery expansion due to other less critical factors.

In accordance with embodiments of the present disclosure, conditions for imminent thermal runaway are detected based on a rate of battery expansion. The rate of battery expansion can be correlated to the rate of thermal temperature rise in the battery. In response to detecting the thermal runaway conditions, mitigating steps can be applied to address the thermal runaway with minimum disruption to the components that rely on the battery.

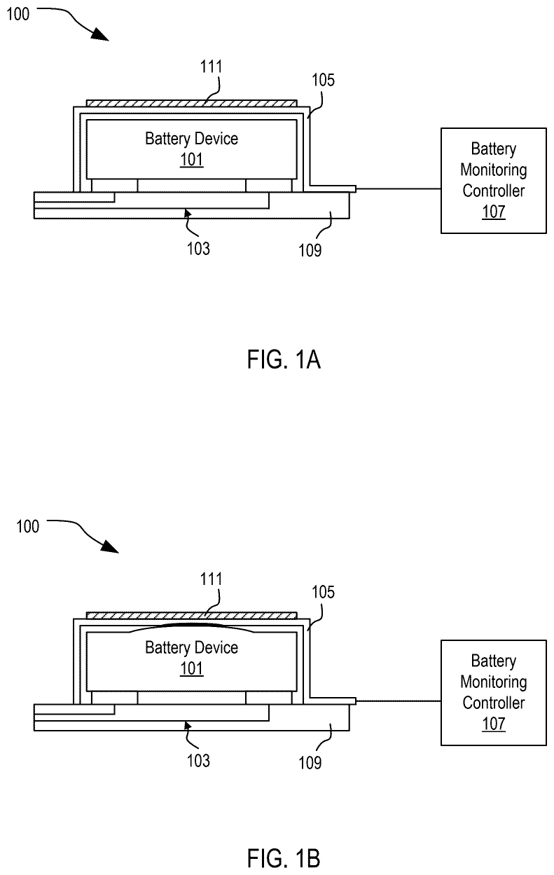

FIGS. 1A and 1B set forth a diagram of an example system 100 for thermal runaway event detection in accordance with at least one embodiment of the present disclosure. FIG. 1A includes a battery device 101 such as a lithium-ion battery device. The battery device 101 is attached to a circuit board 109 and discharges current to an electric circuit through leads 103, and conversely receives current through leads 103 for charging the battery device 101. In some examples, the battery device 101 is a battery cell in a battery pack. In other examples, the battery device 101 is the battery pack itself or a monolithic battery device such as a lithium-ion polymer battery. In examples where the battery device 101 is a cell, a battery pack can include multiple cells that are connected in series, referred to herein as a ‘string.’ Multiple strings may be connected in parallel within the battery pack. If necessary, a string can be deactivated while allowing the battery device 101 to continue functioning through the remaining active strings.

The example system 100 also includes an expansion sensor 105 configured to detect an expansion in the volume of the battery device 101. In some examples, the expansion sensor 105 is a flexible circuit comprising metal conductive structures on or within a deformable insulating material. The expansion sensor 105 substantially conforms to the shape of the battery device 101 such that a change in volume of the battery device also changes the shape of the expansion sensor 105. In some implementations, the expansion sensor 105 includes multiple layers of conductive structures and insulating material. In some implementations, the conductive structures exhibit piezoresistive characteristics. In some implementations, the expansion sensor 105 is film or conductive adhesive band that is layered above the battery device 101. During operation, an expansion of the battery volume causes a deformation of the expansion sensor 105, which in turn causes a deformation of the conductive structures, thus changing an output of the flexible circuit in the expansion sensor 105.

In one example of operation, deformation of the expansion sensor 105 due to expansion of the battery device 101, as shown in FIG. 1B, causes contact between one or more conductive structures, which changes the electrical output of the expansion sensor 105. For example, contact between two conductive structures may cause a short in the flexible circuit, which changes the continuity of the output of the flexible circuit. In some implementations, where multiple levels of conductive structures are separated by the deformable insulating material, a degree of expansion may be detected based on the number of layers that come into contact. For example, a first degree of battery expansion may be detected when deformation of the expansion sensor causes a conductive structure in a first layer to contact a conductive structure in a second layer above the first layer. A second degree of battery expansion may be detected when deformation of the expansion sensor causes a conductive structure in the second layer to contact a conductive structure in a third layer above the second layer. The highest degree of expansion is detected when a conductive structure in the last layer (farthest away from the surface of the battery device 101) contacts a conductive structure in the second-to-last layer. In some implementations, contact between particular layers causes a particular change in the output of the expansion sensor, such that the degree of expansion can be detected based on the particular change in the output of the flexible circuit.

In another example of operation, deformation of the expansion sensor 105 due to expansion of the battery device, as shown in FIG. 1B, 101 causes a deformation of one or more conductive structures, which changes the resistive characteristics of the conductive structure. That is, the electrical resistivity of conductor changes in response to the mechanical strain is applied to the conductor as a result of deformation of the expansion sensor 105. This changes the electrical output of the expansion sensor 105. In some examples, a degree of deformation of the expansion sensor 105 is detectable based on the degree of change in the electrical resistivity of the conductor. In other words, the degree of change in electrical resistivity in the expansion sensor 105 correlates to the degree of expansion of the battery volume that caused the deformation of the expansion sensor 105.

The system 100 also includes a battery monitoring controller 107 that receives the electrical output of the expansion sensor 105. In some examples, the battery monitoring controller 107 detects battery expansion based on readings from one or more expansion sensors at successive time intervals. For example, the battery monitoring controller 107 may detect a short between two conductors in the flexible circuit of the expansion sensor by reading the electrical output of the expansion sensor 105. Each reading indicates a level of battery expansion at a particular point in time. Based on this time series of detections of levels or degrees of battery expansion, the battery monitoring controller 107 detects a rate of battery expansion of a particular period of time. For example, contact between two conductive structures in the expansion sensor triggers a first reading at the battery monitoring controller 107, indicating a first level of expansion. Contact between two other conductive structures in the expansion sensor triggers a second reading at the battery monitoring controller 107, indicating a second level of expansion. The time interval between these two readings is used to calculate the rate of battery expansion. In another example, mechanical strain applied to a conductor in the expansion sensor 105 triggers a first resistance reading at the battery monitoring controller 107, indicating a first degree of expansion. At a second point in time, mechanical strain applied to the conductor in the expansion sensor 105 triggers a second resistance reading at the battery monitoring controller 107, indicating a second degree of expansion. The time interval between these two readings and the difference in the resistance indicated by the readings is used to calculate the rate of battery expansion.

The battery monitoring controller 107 uses the rate of battery expansion measured through the time series detections of battery expansion to detect whether conditions are present for a thermal runaway event. In some implementations, conditions for a thermal runaway event are detected when the rate of battery expansion exceeds a particular threshold. That is, the rate of expansion can indicate a rate of temperature increase in the battery, which as discussed above causes the expansion of the battery. In some examples, the battery monitoring controller 107 determines whether the rate of battery expansion indicates acceptable expansion based on normal operating conditions. For example, a battery device can be expected to expand by a certain degree corresponding to a length of operating time. As the battery device operates for a long period of time, the battery device is expected to expand by an acceptable amount. A battery device can also be expected to expand by an acceptable amount due to the battery device's age. An older battery will expand to a greater degree. However, a rapid expansion may indicate that thermal runaway is occurring or about to occur. A rapid rate of battery expansion, or a rate of battery expansion that exceeds a preconfigured threshold, indicates that the operating conditions of the battery device 101 correspond to a thermal runaway event. Thus, in some implementations, the battery monitoring controller 107 uses the rate of battery expansion to predict that a thermal runaway event is occurring or imminent.

The battery monitoring controller 107 is configured to perform a thermal runaway remediation action in response to detecting conditions for the thermal runaway event. In some implementation, a thermal runaway remediation action includes deactivating the battery device 101 that is potentially failing due to a thermal runaway event, or deactivating a string of battery devices that includes the potentially failing battery device. Deactivating the battery device 101 can be carried out by opening a switch such that the battery device 101 is no longer used to supply current to the circuit 109. In some implementations, a thermal runaway remediation action includes reducing a current drawn from the battery device 101. In these implementations, the battery device 101 is not completely deactivated. In some implementations, a thermal runaway remediation action includes activating a cooling device, such as a thermoelectric cooling device 111 described below. The cooling device reduces the temperature in the battery device 101, which can mitigate or prevent the thermal runaway event. In various implementations, activation of the cooling device can be used in conjunction with deactivating the battery device 101 or reducing the current drawn from the battery device 101.

In some examples, the system 100 also includes a thermoelectric cooling device 111, such as a Peltier device. A Peltier device is a solid-state device that utilizes the Peltier effect to transfer heat between two different materials. This phenomenon occurs when an electric current flows through two dissimilar conductors or semiconductors, causing a heat transfer at the junction of the materials. In some implementations, a Peltier device includes multiple pairs of p-type and n-type semiconductor materials connected electrically in series and thermally in parallel. When an electric current passes through the device, heat is absorbed at one junction (the cold side) and released at the other junction (the hot side). This allows the Peltier device to act as a heat pump, moving thermal energy from one side to the other. In some implementations, the thermoelectric cooling device 111 is layered on top of the expansion sensor 105. In other implementations, the thermoelectric cooling device 111 is disposed between the battery device 101 and the expansion sensor 105. In some implementations, when the thermoelectric cooling device 111 is activated to cool a battery device 101 in a thermal runaway condition, the thermoelectric cooling device 111 draws power from one or more other battery devices that remain in a normal operating condition. The thermoelectric cooling device 111 may be a thin film device.

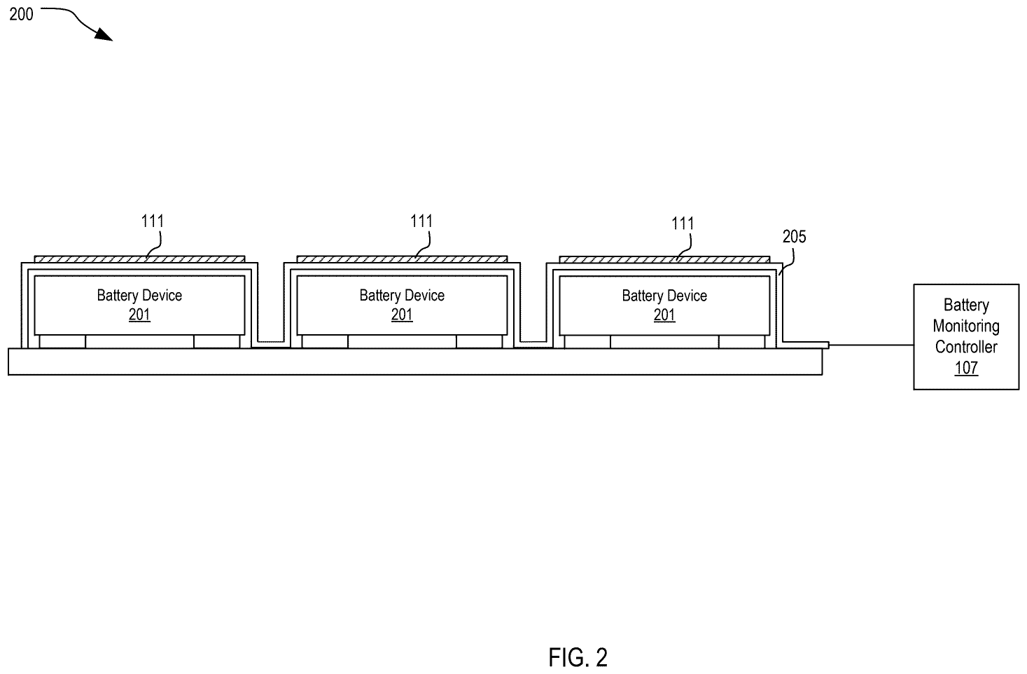

FIG. 2 sets forth a diagram of another example system 200 for thermal runaway event detection in accordance with at least one embodiment of the present disclosure. The example of FIG. 2 differs from the example of FIG. 1A in that the example of FIG. 2 includes multiple battery cells 201. For example, the multiple battery cells 201 are lithium-ion battery cells. In some examples, the multiple battery cells 201 are connected in series to form a string. An expansion sensor 205 is similar in configuration and operation to the expansion sensor 105 of FIG. 1A except that the expansion sensor 205 is embodied in an elongated flexible conductive strip that is layered over each of the multiple battery cells 201. Thus, the expansion sensor 205 is configured to detect battery expansion in any of the battery cells 201 in the same manner as described above. However, an expansion in any one battery cell will cause the expansion sensor to indicate battery expansion without specificity to a particular cell. Thus, in some implementations, multiple expansion sensors 205 are arranged in a grid to provide sufficient granularity to determine the particular battery cell for which expansion is detected.

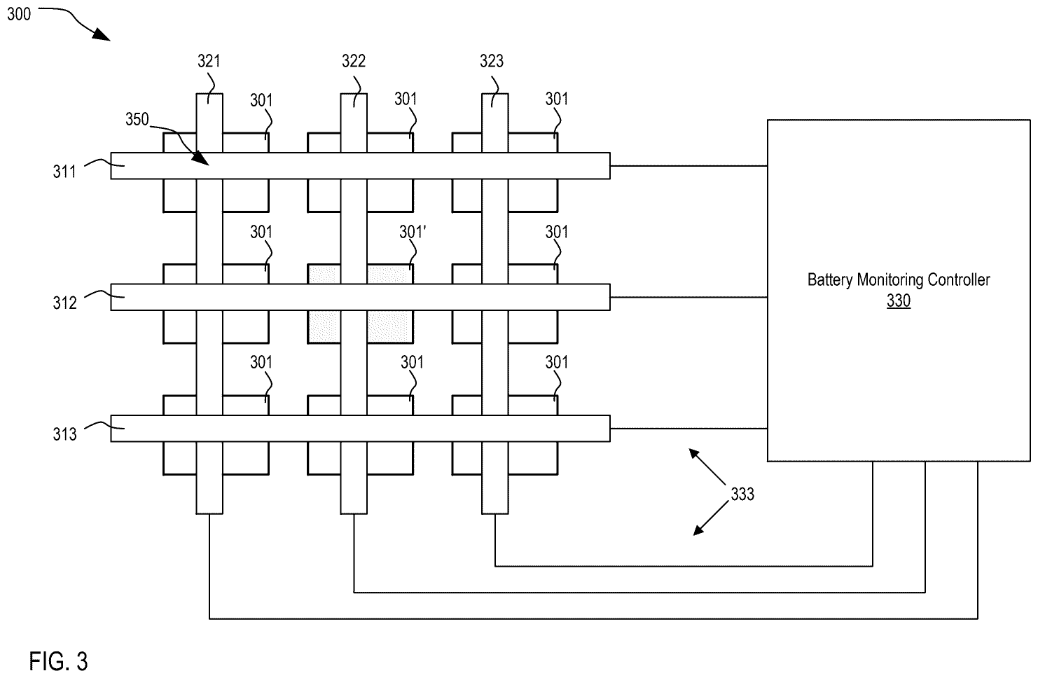

FIG. 3 sets forth a diagram of another example system 300 for thermal runaway event detection in accordance with at least one embodiment of the present disclosure. The example of FIG. 3 includes an array of battery cells 301 arranged in columns and rows. It will be appreciated by those of skill in the art that the battery cells may be organized in other configurations and with any number of battery cells; however, the arrangement of rows and columns of battery cells in FIG. 3 is selected to simplify the description. A grid 350 of expansion sensors, including rows of expansion sensors 311, 312, 313 and columns of expansion sensors 321, 322, 323, is layered over the array of battery cells 301. The expansion sensors are electrically coupled to a battery monitoring controller 330 by signal lines 333. It is noted that a signal line 333 between a particular expansion sensor and the battery monitoring controller 330 may include two or more lines to create a circuit, thus allowing a continuity check to be used to detect battery expansion. An expansion by any battery cell within a row or column will trigger the expansion sensor that is layered over that row or column. The use of a single expansion sensor for an entire row or column of battery cells simplifies the detection mechanism and reduces the number of signal lines to the battery monitoring controller. To pinpoint which battery cell is exhibiting expansion, the battery monitoring controller 330 receives a signal from one of the column expansion sensors and one of the row expansion sensors, which identifies the column-row location of the battery cell exhibiting the expansion. For example, when the highlighted battery cell 301′ is experiencing expansion, this will trigger row expansion sensor 312 and column expansion sensor 322. The battery monitoring controller 330 can then determine that it is battery cell 301′ that is exhibiting expansion. In some examples, each expansion sensor also detects a degree of expansion.

It is noted that a tighter grid having a finer granularity could be employed to detect expansion at particular portions of the battery cell that are exhibiting expansion (e.g., a particular quadrant of the battery cell). While the grid 350 is described as being layered over an array of battery cells, it will be appreciated that the grid 350 may also be layered over a monolithic battery pack. In this way, the battery monitoring controller 330 using the grid 350 can pinpoint specific areas of the battery pack that are exhibiting expansion and can therefore determine how widespread the expansion is. For example, the expansion could be localized to a particular portion of the battery pack or could be detected more broadly.

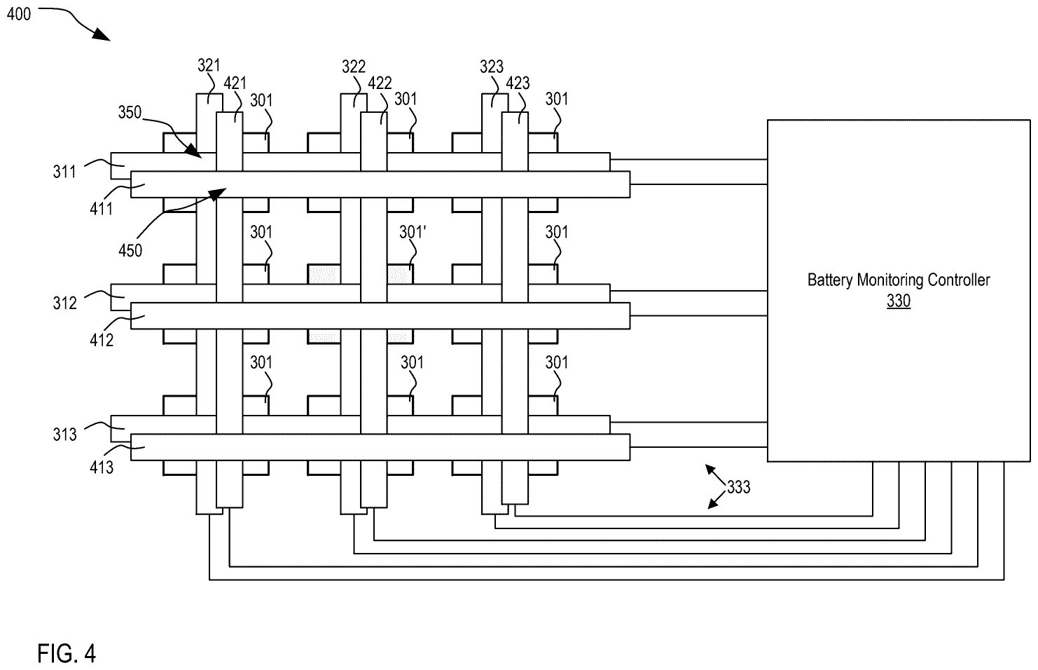

FIG. 4 sets forth a diagram of another example system 400 for thermal runaway event detection in accordance with at least one embodiment of the present disclosure. The example of FIG. 4 is similar to the example of FIG. 3 except that the example of FIG. 4 includes a second grid 450 of expansion sensors layer on top of the first grid 350. The second grid 450 includes rows of expansion sensors 411, 412, 413 and columns of expansion sensors 421, 422, 423 layered over battery cells 301 and the first grid 350. The second grid 450 provides more detail as to the degree of expansion. For example, a battery cell exhibiting a particular degree of expansion will trigger an expansion sensor in the first grid. When the battery cell exhibits an even greater degree of expansion, this will trigger an expansion sensor in the second grid. The battery monitoring controller 330 then uses these readings to determine the rate of expansion in that battery cell. In some examples, the second grid is offset from the first grid in partial overlap as shown in FIG. 4. In other examples, the second grid may be layered to completely overlap the first grid 350. It will be appreciated that any number of grids of expansion sensors could be layered upon each other.

Continuing the above example, when the highlighted battery cell 301′ is experiencing expansion, this will trigger row expansion sensor 312 and column expansion sensor 322 at a first point in time. The battery monitoring controller 330 can then determine that it is battery cell 301′ that is exhibiting expansion. As the highlighted battery cell 301′ continues to expand, it will trigger row expansion sensor 412 and column expansion sensor 422 at a second point in time. The battery monitoring controller 330 can then determine that battery cell 301′ has expanded to a greater degree since the first point in time, and can therefore detect the rate of expansion.

In some implementations, the battery monitoring controller described above is embodied in a set of computer programing instructions that, when executed by a processor, cause the processor to carry out the above-described aspects of the battery monitoring controller. In other implementations, the battery monitoring controller is embodied in an integrated circuit such as an application specific integrated circuit or programmable logic device.

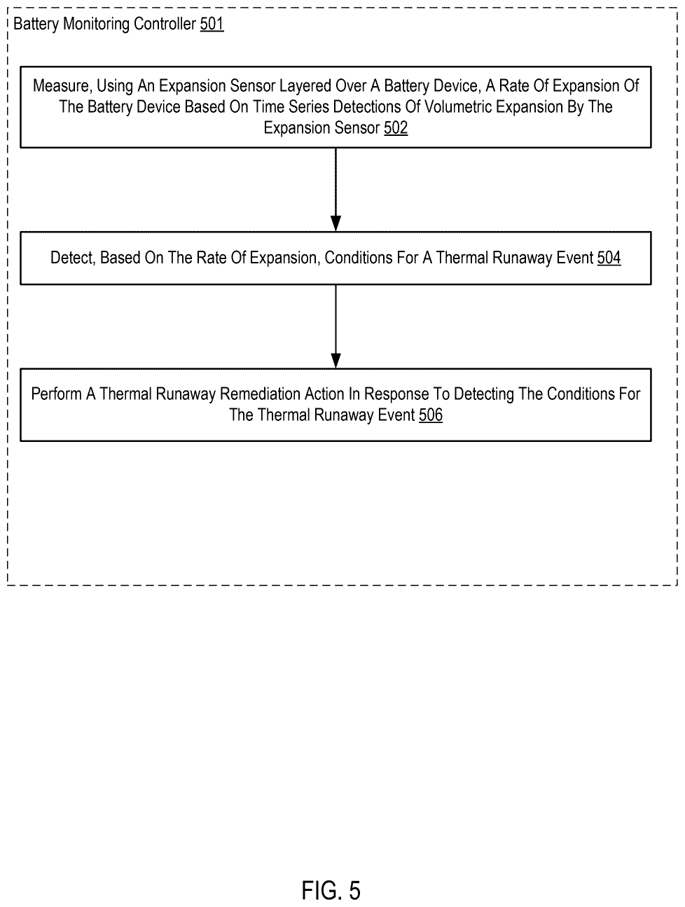

For further explanation, FIG. 5 sets forth a flow chart of an example method for thermal runaway event detection in accordance with at least one embodiment of the present disclosure. The example method may be carried out by a battery monitoring controller 501 such as any of the battery monitoring controllers described above. The method of FIG. 5 includes measuring 502, using an expansion sensor layered over a battery device, a rate of expansion of the battery device based on time series detections of volumetric expansion by the expansion sensor. In some examples, the battery monitoring controller 501 measures 502 the rate of expansion of the battery device by detecting a change in the output of the expansion sensor due to volumetric expansion, such as swelling or bulging, of the battery device.

In some implementations, the change in output of the expansion sensor is a change in continuity in the expansion sensor. For example, the expansion sensor can include two or more disconnected conductive leads that are electrically coupled to the battery monitoring controller 501. When deformation of the expansion sensor, due to battery expansion, causes two conductors to short, the battery monitoring controller 501 detects the change in continuity as volumetric expansion of the battery device. Thus, in these implementations, volumetric expansion of the battery device is indicated by a change in continuity of one or more conductors in the expansion sensor.

In some implementations, the change in output of the expansion sensor is a change in resistance in the expansion sensor as measured by the battery monitoring controller 501. For example, when deformation of the expansion sensor, due to battery expansion, causes strain on one or more conductors in the expansion sensor, the battery monitoring controller 501 detects the change in resistance in the conductor due to the piezoresistive effect. This change in resistance corresponds to a change in deformation of the expansion sensor, which corresponds to volumetric expansion of the battery device. Thus, in these implementations, the degree of volumetric expansion of the battery device is indicated by a change in resistance in the expansion sensor. Accordingly, the battery monitoring controller 501 is configured to associate particular resistance measurements with particular degrees of expansion of the battery device.

In various examples, the battery device may be a battery cell or a battery pack. In some implementations, the expansion sensor is a flexible linear sensor strip. For example, the expansion sensor can include one or more layers of conductors and insulating material (e.g., polyimide) and an adhesive layer. In some examples, the conductors include a meshed grid of conductors. In some examples, the expansion sensor is embodied in a thin-film ribbon. In some examples, the expansion sensor is layered over multiple cells (i.e., battery devices) in a battery pack, as shown above.

In some implementations, a grid of expansion sensors is layered over the battery device and, in a particular example, over multiple cells of the battery device, where each of the expansion sensors in the grid is a flexible sensor strip. For example, there may be a respective expansion sensor for each row of cells and a respective expansion sensor for each column of cells, forming the grid of expansion sensors. When a particular cell is expanding, the volumetric expansion is located by identifying a detection of volumetric expansion in a row expansion sensor and a corresponding (at the same time) volumetric expansion in a column expansion sensor. Thus, in some examples, measuring 502 a rate of expansion of the battery device based on time series detections of volumetric expansion includes measuring a rate of expansion of a particular battery cell based on detections of volumetric expansion from two expansion sensors in the grid of expansion sensors, i.e., a column expansion sensor and a row expansion sensor.

In some implementations, a second grid of expansion sensors is layered over the first grid of expansion sensors. It will be appreciated the further grids can be layered over the second grid. In these implementations, a rate of expansion can be identified by a detection of volumetric expansion at a row-column location in the first grid at a first point in time followed by a volumetric expansion at the same row-column location in the second grid at a second point in time. Given that the second grid is farther from the surface of the battery device than the first grid, a detection at the second grid indicates that volumetric expansion has increased. Thus, the rate of increase is determined based on detections by the first and second grids.

The method of FIG. 5 also includes detecting 504, based on the rate of expansion, conditions for a thermal runaway event. In some examples, the battery monitoring controller 501 detects 504 conditions for a thermal runaway event by comparing a value of the rate of expansion to a threshold value. For example, the threshold value can be a ratio of the increase in volumetric expansion to time, an amount of time elapsed between detections at a first level and a second level of volumetric expansion, a derivative of the rate of expansion indicating the change in the rate of expansion, and so on. When the value for the rate of expansion is within the threshold, the battery monitoring controller 501 can determine that conditions for a thermal runaway event are not present, or at least not present yet. When the value for the rate of expansion is not within the threshold, the battery monitoring controller 501 can determine that conditions for a thermal runaway event are present and predict that a thermal runaway event is imminent or occurring.

The method of FIG. 5 also includes performing 506 a thermal runaway remediation action in response to detecting the conditions for the thermal runaway event. In some examples, the battery monitoring controller 501 performs 506 a thermal runaway remediation action by deactivating the battery device. In some examples, the battery monitoring controller 501 performs 506 a thermal runaway remediation action by deactivating a particular cell that is expanding or a string of cells that includes the particular cell. In some examples, the battery monitoring controller 501 performs 506 a thermal runaway remediation action by reducing current drawn on the battery device. As will be explained in greater detail below, in some examples the battery monitoring controller 501 performs 506 a thermal runaway remediation action by activating a thermoelectric cooling device.

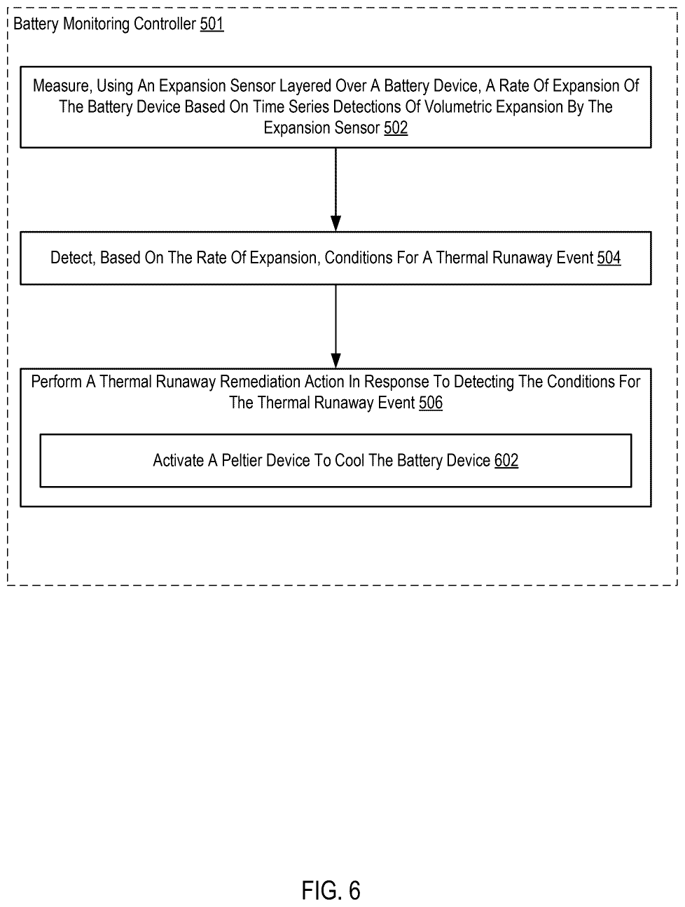

For further explanation, FIG. 6 sets forth another example method of thermal runaway event detection in accordance with at least one embodiment of the present disclosure. The method of FIG. 6 extends the method of FIG. 5 in that performing 506 a thermal runaway remediation action in response to detecting the conditions for the thermal runaway event includes activating 602 a thermoelectric cooling device configured to cool the battery device. In some examples, the battery monitoring controller 501 activates 602 a thermoelectric cooling device that is layered over the battery device. For example, the thermoelectric cooling device can be a Peltier device. In some examples, a thermoelectric cooling device is layered over each cell in the battery. When a particular cell is failing or in condition for thermal runaway, the thermoelectric cooling device layered over that cell is activated to cool the cell. In some implementations, the thermoelectric cooling device is powered by one or more other cells that are not in a state of failure. Active cooling of the battery device in response to conditions for thermal runaway can prevent the thermal runaway event and can stop thermal runaway event if it is already underway.

In view of the foregoing, it will be appreciated that aspects of the present disclosure improve the functioning of a computer system coupled to a battery power supply by providing a mechanism, using a rate of expansion, to distinguish between typical or acceptable battery expansion and battery expansion that is indicative of thermal runaway conditions. This can prevent premature deactivation of the battery device, thus reducing the disruption to the operation of the computer system. Further, aspects provide a mechanism to cool the battery device in response to detecting thermal runaway conditions, which can mitigate the thermal runaway conditions and further ensure that the computer system remains operational.

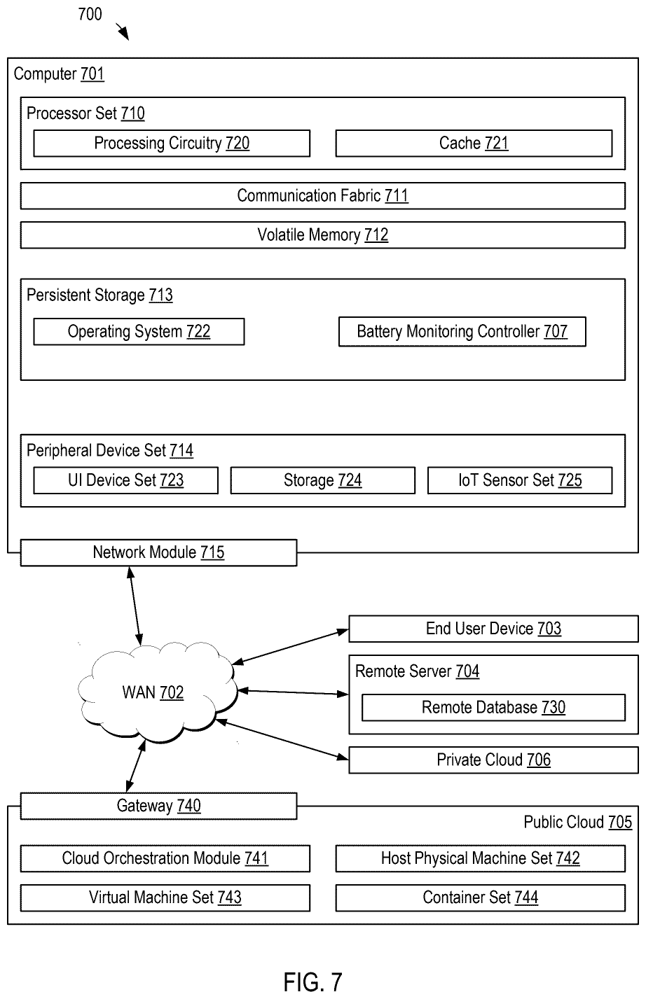

FIG. 7 sets forth an example computing environment according to aspects of the present disclosure. Computing environment 700 contains an example of an environment for the execution of at least some of the computer code involved in performing the various methods described herein, such as battery monitoring controller 707. In addition to block 707, computing environment 700 includes, for example, computer 701, wide area network (WAN) 702, end user device (EUD) 703, remote server 704, public cloud 705, and private cloud 706. In this embodiment, computer 701 includes processor set 710 (including processing circuitry 720 and cache 721), communication fabric 711, volatile memory 712, persistent storage 713 (including operating system 722 and block 707, as identified above), peripheral device set 714 (including user interface (UI) device set 723, storage 724, and Internet of Things (IoT) sensor set 725), and network module 715. Remote server 704 includes remote database 730. Public cloud 705 includes gateway 740, cloud orchestration module 741, host physical machine set 742, virtual machine set 743, and container set 744.

Computer 701 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 730. As is well understood in the art of computer technology, and depending upon the technology, performance of a computer-implemented method may be distributed among multiple computers and/or between multiple locations. On the other hand, in this presentation of computing environment 700, detailed discussion is focused on a single computer, specifically computer 701, to keep the presentation as simple as possible. Computer 701 may be located in a cloud, even though it is not shown in a cloud in FIG. 7. On the other hand, computer 701 is not required to be in a cloud except to any extent as may be affirmatively indicated.

Processor set 710 includes one, or more, computer processors of any type now known or to be developed in the future. Processing circuitry 720 may be distributed over multiple packages, for example, multiple, coordinated integrated circuit chips. Processing circuitry 720 may implement multiple processor threads and/or multiple processor cores. Cache 721 is memory that is located in the processor chip package(s) and is typically used for data or code that should be available for rapid access by the threads or cores running on processor set 710. Cache memories are typically organized into multiple levels depending upon relative proximity to the processing circuitry. Alternatively, some, or all, of the cache for the processor set may be located “off chip.” In some computing environments, processor set 710 may be designed for working with qubits and performing quantum computing.

Computer readable program instructions are typically loaded onto computer 701 to cause a series of operational steps to be performed by processor set 710 of computer 701 and thereby effect a computer-implemented method, such that the instructions thus executed will instantiate the methods specified in flowcharts and/or narrative descriptions of computer-implemented methods included in this document. These computer readable program instructions are stored in various types of computer readable storage media, such as cache 721 and the other storage media discussed below. The program instructions, and associated data, are accessed by processor set 710 to control and direct performance of the computer-implemented methods. In computing environment 700, at least some of the instructions for performing the computer-implemented methods may be stored in block 707 in persistent storage 713.

Communication fabric 711 is the signal conduction path that allows the various components of computer 701 to communicate with each other. Typically, this fabric is made of switches and electrically conductive paths, such as the switches and electrically conductive paths that make up buses, bridges, physical input/output ports and the like. Other types of signal communication paths may be used, such as fiber optic communication paths and/or wireless communication paths.

Volatile memory 712 is any type of volatile memory now known or to be developed in the future. Examples include dynamic type random access memory (RAM) or static type RAM. Typically, volatile memory 712 is characterized by random access, but this is not required unless affirmatively indicated. In computer 701, the volatile memory 712 is located in a single package and is internal to computer 701, but, alternatively or additionally, the volatile memory may be distributed over multiple packages and/or located externally with respect to computer 701.

Persistent storage 713 is any form of non-volatile storage for computers that is now known or to be developed in the future. The non-volatility of this storage means that the stored data is maintained regardless of whether power is being supplied to computer 701 and/or directly to persistent storage 713. Persistent storage 713 may be a read only memory (ROM), but typically at least a portion of the persistent storage allows writing of data, deletion of data and re-writing of data. Some familiar forms of persistent storage include magnetic disks and solid state storage devices. Operating system 722 may take several forms, such as various known proprietary operating systems or open source Portable Operating System Interface-type operating systems that employ a kernel. The code included in block 707 typically includes at least some of the computer code involved in performing the computer-implemented methods described herein.

Peripheral device set 714 includes the set of peripheral devices of computer 701. Data communication connections between the peripheral devices and the other components of computer 701 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 723 may include components such as a display screen, speaker, microphone, wearable devices (such as goggles and smart watches), keyboard, mouse, printer, touchpad, game controllers, and haptic devices. Storage 724 is external storage, such as an external hard drive, or insertable storage, such as an SD card. Storage 724 may be persistent and/or volatile. In some embodiments, storage 724 may take the form of a quantum computing storage device for storing data in the form of qubits. In embodiments where computer 701 is required to have a large amount of storage (for example, where computer 701 locally stores and manages a large database), this storage may be provided by peripheral storage devices designed for storing very large amounts of data, such as a storage area network (SAN) that is shared by multiple, geographically distributed computers. IoT sensor set 725 is made up of sensors that can be used in Internet of Things applications. For example, one sensor may be a thermometer and another sensor may be a motion detector.

Network module 715 is the collection of computer software, hardware, and firmware that allows computer 701 to communicate with other computers through WAN 702. Network module 715 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 715 are performed on the same physical hardware device. In other embodiments (for example, embodiments that utilize software-defined networking (SDN)), the control functions and the forwarding functions of network module 715 are performed on physically separate devices, such that the control functions manage several different network hardware devices. Computer readable program instructions for performing the computer-implemented methods can typically be downloaded to computer 701 from an external computer or external storage device through a network adapter card or network interface included in network module 715.

WAN 702 is any wide area network (for example, the internet) capable of communicating computer data over non-local distances by any technology for communicating computer data, now known or to be developed in the future. In some embodiments, the WAN 702 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

End user device (EUD) 703 is any computer system that is used and controlled by an end user (for example, a customer of an enterprise that operates computer 701), and may take any of the forms discussed above in connection with computer 701. EUD 703 typically receives helpful and useful data from the operations of computer 701. For example, in a hypothetical case where computer 701 is designed to provide a recommendation to an end user, this recommendation would typically be communicated from network module 715 of computer 701 through WAN 702 to EUD 703. In this way, EUD 703 can display, or otherwise present, the recommendation to an end user. In some embodiments, EUD 703 may be a client device, such as thin client, heavy client, mainframe computer, desktop computer and so on.

Remote server 704 is any computer system that serves at least some data and/or functionality to computer 701. Remote server 704 may be controlled and used by the same entity that operates computer 701. Remote server 704 represents the machine(s) that collect and store helpful and useful data for use by other computers, such as computer 701. For example, in a hypothetical case where computer 701 is designed and programmed to provide a recommendation based on historical data, then this historical data may be provided to computer 701 from remote database 730 of remote server 704.

Public cloud 705 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 705 is performed by the computer hardware and/or software of cloud orchestration module 741. The computing resources provided by public cloud 705 are typically implemented by virtual computing environments that run on various computers making up the computers of host physical machine set 742, which is the universe of physical computers in and/or available to public cloud 705. The virtual computing environments (VCEs) typically take the form of virtual machines from virtual machine set 743 and/or containers from container set 744. It is understood that these VCEs may be stored as images and may be transferred among and between the various physical machine hosts, either as images or after instantiation of the VCE. Cloud orchestration module 741 manages the transfer and storage of images, deploys new instantiations of VCEs and manages active instantiations of VCE deployments. Gateway 740 is the collection of computer software, hardware, and firmware that allows public cloud 705 to communicate through WAN 702.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

Private cloud 706 is similar to public cloud 705, except that the computing resources are only available for use by a single enterprise. While private cloud 706 is depicted as being in communication with WAN 702, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 705 and private cloud 706 are both part of a larger hybrid cloud.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

The descriptions of the various embodiments of the present disclosure have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A method comprising:
measuring, using an expansion sensor layered over a battery device, a rate of expansion of the battery device based on time series detections of volumetric expansion by the expansion sensor;
detecting, based on the rate of expansion, conditions for a thermal runaway event; and
performing a thermal runaway remediation action in response to detecting the conditions for the thermal runaway event.

2. The method of claim 1, wherein volumetric expansion of the battery device is indicated by a change in continuity of one or more conductors in the expansion sensor.

3. The method of claim 1, wherein a degree of volumetric expansion of the battery device is indicated by a change in resistance in the expansion sensor.

4. The method of claim 1, wherein the expansion sensor is a flexible linear sensor strip.

5. The method of claim 4, wherein the expansion sensor is layered over multiple cells of the battery device.

6. The method of claim 4, wherein the expansion sensor is one of a plurality of expansion sensor strips forming a first grid of expansion sensors layered over the battery device; and wherein volumetric expansion is detected at a particular portion of the battery device based on detections by intersecting expansion sensor strips.

7. The method of claim 6, wherein a second grid of expansion sensors is layered on the first grid of expansion sensors; and wherein the rate of expansion of the battery device is measured based on detections by the first grid and the second grid.

8. The method of claim 1, wherein performing a thermal runaway remediation action in response to detecting the conditions for the thermal runaway event includes:
activating a thermoelectric cooling device configured to cool the battery device.

9. The method of claim 8, wherein the thermoelectric cooling device is located on a first cell that is expanding, and wherein the thermoelectric cooling device is powered by one or more other cells in the battery device.

10. The method of claim 1, wherein the runaway remediation action includes deactivating one or more cells of the battery device.

11. An apparatus comprising:
a battery device;
an expansion sensor layered over the battery device; and
a controller configured to:
measure a rate of expansion of the battery device based on time series detections of volumetric expansion by the expansion sensor;
detect, based on the rate of expansion, conditions for a thermal runaway event; and
perform a thermal runaway remediation action in response to detecting the conditions for the thermal runaway event.

12. The apparatus of claim 11, wherein volumetric expansion of the battery device is indicated by a change in continuity of one or more conductors in the expansion sensor.

13. The apparatus of claim 11, wherein a degree of volumetric expansion of the battery device is indicated by a change in resistance in the expansion sensor.

14. The apparatus of claim 11, wherein the expansion sensor is a flexible linear sensor strip.

15. The apparatus of claim 14, wherein the expansion sensor is layered over multiple cells of the battery device.

16. The apparatus of claim 14, wherein the expansion sensor is one of a plurality of expansion sensor strips forming a first grid of expansion sensors layered over the battery device; and wherein volumetric expansion is detected at a particular portion of the battery device based on detections by intersecting expansion sensor strips.

17. The apparatus of claim 16, wherein a second grid of expansion sensors is layered on the first grid of expansion sensors; and wherein the rate of expansion of the battery device is measured based on detections by the first grid and the second grid.

18. The apparatus of claim 11, wherein performing a thermal runaway remediation action in response to detecting the conditions for the thermal runaway event includes:
activating a thermoelectric cooling device configured to cool the battery device.

19. The apparatus of claim 18, wherein the thermoelectric cooling device is located on a first cell that is expanding, and wherein the thermoelectric cooling device is powered by one or more other cells in the battery device.

20. A computer program product comprising a computer readable storage medium, wherein the computer readable storage medium comprises computer program instructions that, when executed:
measure, using an expansion sensor layered over a battery device, a rate of expansion of the battery device based on time series detections of volumetric expansion by the expansion sensor;
detect, based on the rate of expansion, conditions for a thermal runaway event; and
perform a thermal runaway remediation action in response to detecting the conditions for the thermal runaway event.
